(19) United States
(12) Patent Application Publication
(10) Pub. No.: US 2015/0058138 A1
(43) Pub. Date: Feb. 26, 2015

(54) REAL-TIME BIDDING SYSTEM AND METHOD THEREFORE FOR PLACING A VIDEO ADVERTISEMENT IN AN ADVERTISEMENT SLOT

(71) Applicant: Sizmek Technologies Ltd., Herzeliya Pituach (IL)

(72) Inventor: Jonathan Schler, Petach Tikwa (IL)

(73) Assignee: SIZMEK TECHNOLOGIES LTD., Herzeliya Pituach (IL)

(21) Appl. No.: 14/464,351

(22) Filed: Aug. 20, 2014

Related U.S. Application Data
(60) Provisional application No. 61/867,745, filed on Aug. 20, 2013.

(51) Int. Cl. G06Q 30/02

(52) U.S. Cl. CPC G06Q 30/0275
USPC 705/14.71

(57) ABSTRACT

A system and method for bidding on placement a video advertisement in an advertisement slot. The method includes receiving a bid request for placing an advertisement in an advertisement slot is received from a broadcaster, wherein the bid request is received immediately prior to a timing of the advertisement slot in a broadcast content; matching the bid request against different sets of bidding rules, wherein each set of bidding rules is defined by a different advertisement agency; computing a bidding score for each advertisement agency based on the matching to the bidding rules; selecting a winning bid based, in part, on bidding scores computed for each advertisement agency; and responding with the winning bid from the broadcaster.

### CROSS REFERENCE TO RELATED APPLICATIONS

This application claims the benefit of U.S. Provisional Application No. 61/867,745 filed Aug. 20, 2013, the contents of which are incorporated by reference.

### TECHNICAL FIELD

The invention generally relates to bidding systems for advertisement slots, and more specifically to real-time bidding systems for insertion of video advertisements in a broadcast transmission.

### BACKGROUND

The world of digital delivery of multimedia content to viewers has been rapidly progressing. Typical types of multimedia content include video clips, electronic games, and interactive content. The delivery process for such multimedia content, particularly those transmitted in the form of video, may entail use of a variety of delivery standards, video quality levels, and other parameters. The techniques used in traditional television (TV) broadcast cannot be effectively used in the more modern multi-standard digital TV arena.

The broadcasting of televised content is performed using, for example, cable, satellite, and internet protocol TV (IPTV), and over-the-top (OTT) content providers. Typically, legacy providers have full control over the entire delivery chain from a central location to end-users. OTT content providers typically deliver content while connected over the Internet and/or a broadband network without controlling the redistribution of the content. Rather, such providers merely control the content viewed by end users. Examples for OTT content providers are Netflix®, Hulu®, and the like.

The televised content providers establish means for placing advertisements in various advertisement slots within the televised content. However, there is no efficient solution for competition for the various advertisement slots, and in particular the current broadcast television advertisement workflow does not use bidding in general, or real-time bidding in particular.

Typically, television advertisement content is provided to the broadcasting station or source using one of several delivery mechanisms such as uplink and direct digital copy. When it is time for the advertisement to appear in the video stream broadcast by the station, the station's scheduling technology injects the advertisement into the stream. Specifically, unlike the online ad ad-serving approach, the television advertisement workflow does not include any generic agency advertisement-serving mechanism. Thus, the mechanism creates certain challenges when it comes to real-time bidding for advertisement slots.

Therefore, in recognition of the deficiencies of the prior art, it would be advantageous to overcome the lack of a solution for serving bids in real-time for advertisement placement in television programming.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all embodiments. Its sole purpose is to present some concepts of one or more embodiments in a simplified form as a prelude to the more detailed description that is presented later. For convenience, the term some aspects may be used herein to refer to a single aspect or multiple aspects of the disclosure.

The disclosure relates in various embodiments to a method and system for bidding on placement of a video advertisement in an advertisement slot. The method comprises receiving a bid request for placing an advertisement in an advertisement slot from a broadcaster, wherein the bid request is received immediately prior to a timing of the advertisement slot in a broadcast content; matching the bid request against different sets of bidding rules, wherein each set of bidding rules is defined by a different advertisement agency; computing a bidding score for each advertisement agency based on the matching to the bidding rules; selecting a winning bid based, in part, on bidding scores computed for each advertisement agency; and responding with the winning bid from the broadcaster.

### BRIEF DESCRIPTION OF THE DRAWINGS

The subject matter disclosed herein is particularly pointed out and distinctly claimed in the claims at the conclusion of the specification. The foregoing and other objects, features, and advantages of the embodiments disclosed herein will be apparent from the following detailed description taken in conjunction with the accompanying drawings.

FIG. 1 is a schematic diagram of a network system utilized to describe the various disclosed embodiments for real-time advertisement bidding for advertisement slots;

FIG. 2 is a flowchart describing the operation of the real-time bidding system according to one embodiment;

FIG. 3 is a schematic block diagram of a real-time bidding system according to one embodiment; and

FIG. 4 is a schematic block diagram of a real-time bidding system according to another embodiment.

### DETAILED DESCRIPTION

Various embodiments of the disclosure are described below. It should be apparent that the teachings herein may be embodied in a wide variety of forms and that any specific structure, function, or both being disclosed herein is merely representative. Based on the teachings herein, one skilled in the art should appreciate that an embodiment disclosed herein may be implemented independently of any other embodiments and that two or more of these embodiments may be combined in various ways. For example, an apparatus or a system may be implemented or a method may be practiced using any number of the embodiments set forth herein. In addition, such an apparatus or system may be implemented or such a method may be practiced using other structure, functionality, or structure and functionality in addition to or in place of one or more of the embodiments set forth herein. Furthermore, any embodiment disclosed herein may be embodied by one or more elements of a claim.

The embodiments disclosed herein are examples of the many possible advantageous uses and implementations of the innovative teachings presented herein. In general, statements made in the specification of the application do not necessarily limit any of the various disclosed embodiments. Moreover, some statements may apply to some inventive features but not to others. In general, unless otherwise indicated, singular elements may be in plural and vice versa with no loss of generality. In the drawings, like numerals refer to like parts through several views.

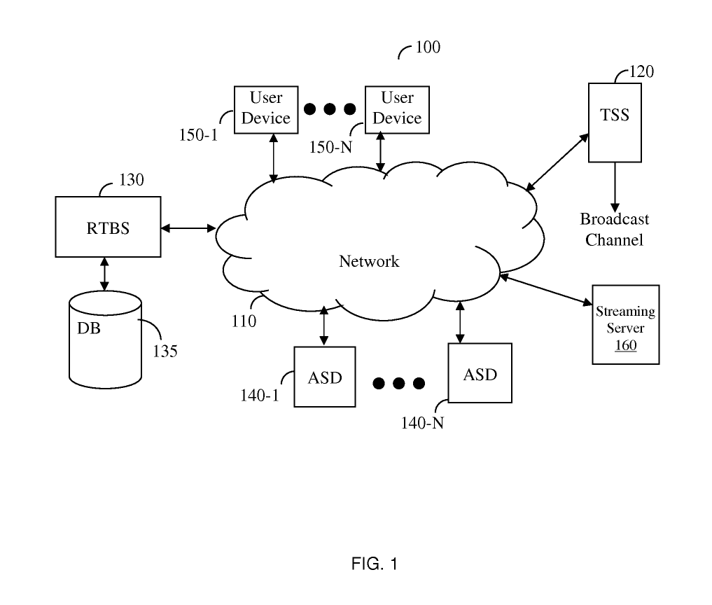

FIG. 1 shows an exemplary and non-limiting schematic diagram of a network system 100 utilized to describe the various disclosed embodiments for real-time advertisement bidding for advertisement slots. A television station server (TSS) 120 is communicatively connected to a network 110. The network 110 may be any combination of wired and/wireless networks including, but not limited to, a local area network, a wide area network (WAN), a metropolitan area network (MAN), the Internet, and the like.

One or more advertisement service databases (ASDs) 140-1 through 140-N, where N is an integer equal to ‘1’ or greater. Each ASD 140 is configured to maintain video advertisements and metadata respective of the video advertisements that allow for placement of a video advertisement contained in an advertisement slot within a video stream broadcast by the TSS 120 based on the winning bid.

A real-time bidding system (RTBS) 130 is also communicatively connected to the network 110. The RTBS 130 is configured to handle bidding requests and placements of video advertisements as further described herein. A database 135 communicatively connected to the RTBS 130 either directly or indirectly (i.e., through the network 110), contains information for the use of the RTBS respective of, for example, agency bidding rules, historical information, viewer (ratings) data, program data, and so on. Such information may be further provided by external sources such as Nielsen®, Rovi®, and the like. The bidding rules are defined by the advertisement agencies according to campaigns' preferences. In an embodiment, the RTBS 130 is configured with a set of application programming interfaces (APIs, not shown) that enable advertisement agencies to enter new bidding rules and/or to modify existing rules.

In an embodiment, the TSS 120 is configured to send, over the network 110, to the RTBS 130 a request for placement of a video advertisement (also referred to as a video ad, or in short, an ad). Such a request is provided at a predetermined period such as, for example, 5 seconds prior to the placement of the video advertisement within the video stream broadcast by the TSS 120. The request sent to the RTBS 130 includes the time of the broadcast of the video advertisement and the television station making the request, and may further include additional parameters, such as the maximum and/or minimum length of the video advertisement, the category of the program when the video advertisement is to be inserted, demographics of the station, and other relevant information.

Responsive of the request received, the RTBS 130 is configured to check the request with respect to the information available in the database 135, and in particular the bidding rules, to determine the winner of the bid for placement of a video advertisement. The RTBS 130 is further configured to inform the TSS 120 and/or an OTT content provider (not shown) of the winning bidder and provides metadata respective of the winning video advertisement.

In one embodiment, the streaming of the video advertisement is provided in real-time from the ASD 140 associated with the agency that provided the winning bid. In another embodiment, the winning video advertisement may already be located in a database (not shown) communicatively connected to the TSS 120 and broadcasting may be provided therefrom.

It should be noted that the TSS 120 may be operated by the broadcast television network (e.g., CBS, NBS, CNN, and the like, and/or a local or regional station such as, e.g., New-York FOX 5, and/or cable and satellite television companies). The RTBS 130 provides means for bidding for advertisement slots by broadcasters providing video streams via the different types of TSS.

In another embodiment, the broadcaster is an OTT content provider. Such providers may utilize streaming servers (e.g., a streaming server 160) to stream media content to user devices 150. A user device 150 may be, but is not limited to, a smartphone, a PC, a tablet computer, a smart TV, and the like. Typically, the streaming servers of OTT content providers are connected to content distribution networks (CDNs).

According to an embodiment, an OTT content provider can send a bidding request to the RTBS 130 for placing an advertisement in a slot with the streamed content. The bidding request is processed as discussed herein to find the best bidder (agency) for the slot. In this embodiment, the advertisement to be placed may be provided from a database, which may be one of the ASDs 140, and the advertisement can be streamed directly to user devices.

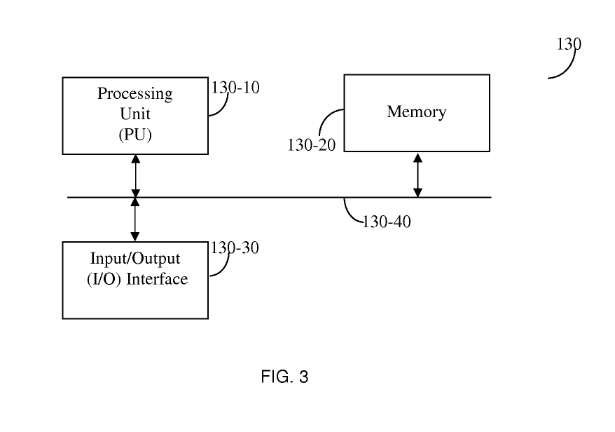

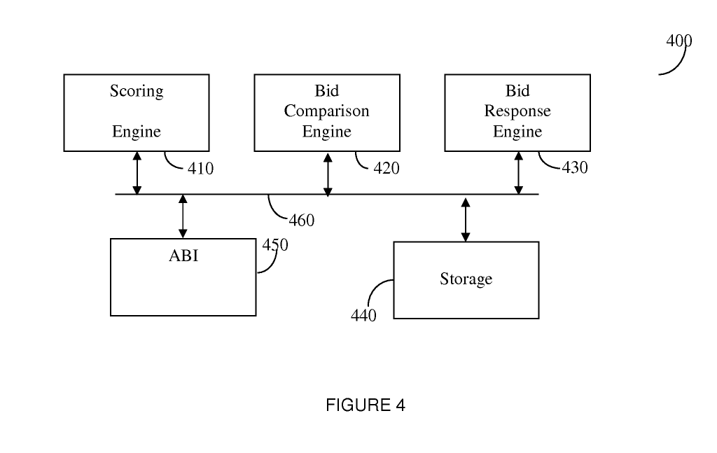

It should be understood by one of ordinary skill in the art that while a single TSS 120 and a streaming server 160 are shown in this embodiment, that the RTBS 130 is typically configured to serve a plurality of TSSs 120, streaming servers 160, and the like. Exemplary and non-limiting embodiments for implementing the RTBS 130 are shown in FIGS. 3 and 4.

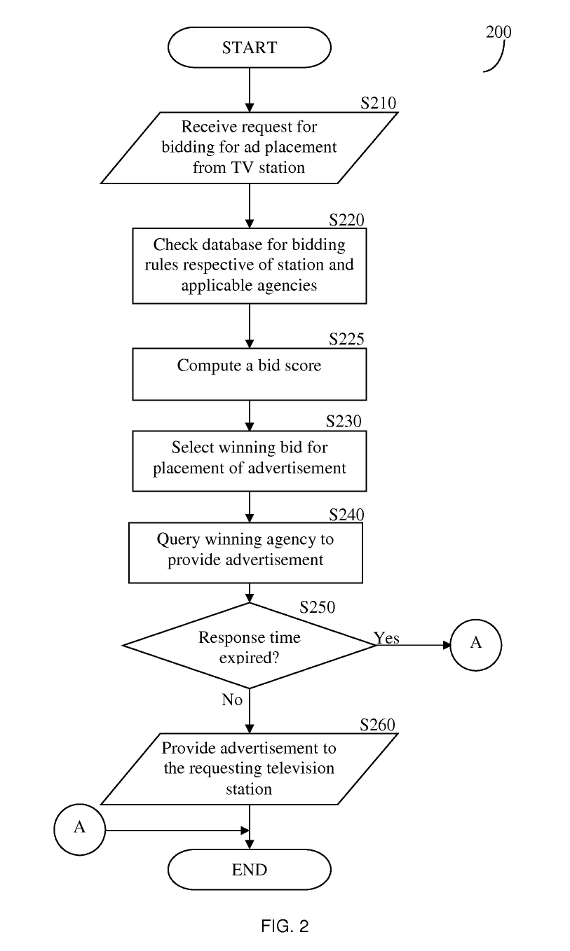

FIG. 2 shows an exemplary and non-limiting flowchart 200 describing the operation of the real-time bidding system (RTBS) 130 according to one embodiment. In S210, a request for a real-time bid on a time slot for a video advertisement is received by the RTBS 130 from a broadcaster (e.g., a TSS 120 or a server 160). Such a request may be issued by the TSS 120 when, for example, there is an available time slot for broadcasting a video advertisement. The real-time bid request may be made for the same time slot at different locations. In an embodiment, the bid request is received immediately prior to a timing of the advertisement slot in a broadcast content, for example, 5 seconds before the slot is available. The bid request is rule-based.

In S220, it is checked if any bidding rules can potentially match the real-time bid request received in S210. A bidding rule defines a set of criteria for the bid and typically associated with a score if the rule is satisfied. The rule's criteria may include, but are not limited to, time, a broadcasting location, a TV channel broadcasting of a desired spot, program information respective of a TV show programmed during the desired spot, viewer data, information regarding advertisements that have already been served, a price range that an agency is willing to pay at each point, and so on. The program information may include, for example, genre, actors, etc., and may be received from external sources such as Rovi. The viewer data may be based on Nielsen ratings and may include ratings/share and total viewers, demographics (e.g., age, gender, race, economic class, and geographical location) of potential viewers, and the like. In one embodiment, each rule includes one or more sub-rules defining a different price range for a different set of criteria.

In S225, a bid score is computed for each matching bid for each agency. A bid is matching when the criteria of one or more rules of agency satisfy the bid request. The bid score is computed by factoring the scores from the matching one or more rules. For example, a bidding rule is defined with the following criteria <ESPN2, adults over 30 years old, Sundays, prime-time> and a score of ‘10’. A bid request is a slot on an ESPN2 show broadcasted on Sunday at 8 pm. The demographic group as determined, for example, from data gathered by Nielsen, is adults over 30 years old, then the rule is satisfied and the score associated with the rule is factored when computer or otherwise providing the matching bid.

In S230, a winning bid among the matching bids computed by the agencies is selected. The selection is based, in part, on the computed bid scores. As noted above, the rules are provided by the different advertisement agencies, therefore the winning bid is the bid by the agency that matched the most rules of the bid request issued by the broadcaster.

In an embodiment, the highest scoring, and hence the best matching, is the winning bid for an advertisement agency. In an exemplary embodiment, in the case where multiple bids have an equal highest score, then the selected bid is that which has the lowest cost bid to the advertisement agency.

According to various embodiments, different bidding strategies may be utilized in S230 to select the winning bid. Such strategies include, but are not limited to, a price increase as time gets closer to airing a potential advertisement, a price decrease as time gets closer to airing a potential advertisement, a combination thereof, or any other strategy, that may be determined based on at least one of historical data respective of the broadcaster, the time slots, the viewer data, programming information, and so on.

The strategy may also determine a limited number of bidders (agencies) to remain in the race for placement of an advertisement by bidding head to head, for example in a round robin fashion. A strategy may be employed to prevent overcrowding of a single advertisement from appearing too frequently, or requiring a higher price if such reoccurrence occurs.

In another embodiment, a bid that is below a minimum requirement may not be accepted even if it is the highest bid; or, a bid that is the highest may not be accepted if it is below a minimum length or above a maximum length; and so on. The bid selection process in one embodiment is based on a total score computed upon receiving bid request. As noted earlier, a score, and hence the total score, may be viewed as the offer is made to the requested bid.

In S240, based on the winning bid, the advertisement source database (e.g., an ASD 140) of the winning agency is queried to provide a video advertisement in the slot on which the bid was made on. In optional S250, it is checked whether there is still time to send the response to the TSS 120 for placing of the video advertisement in the right video advertisement slot (i.e., if the slot has not been elapsed). If not execution terminates; otherwise, execution continues with S260 where the video advertisement or links thereto are provided to the TSS 120 for processing.

FIG. 3 shows an exemplary and non-limiting schematic block diagram of the RTBS 130 according to one embodiment. A processing unit 130-10 comprised of one or more processors is communicatively connected to a memory 130-20 via a bus 130-40. The memory 130-20 may comprise volatile and/or non-volatile memory components, including but not limited to the likes of static random access memory (SRAM), dynamic random access memory (DRAM), Flash memory, magnetic memory and other tangible media on which data and/or instructions may be stored.

An input/output (I/O) interface 130-30 allowing for bidirectional communication to and from the RTBS 130 is further connected to the bus 130-40. The memory 130-20 may contain instructions that, when executed by the processing unit 130-10 performs, for example and without limitations, the bidding processes.

In an embodiment, the bidding processes implemented by the RTBS 130 and performed by the processing unit 130-10 involve receiving bid requests from broadcasters (such as the TSS 120) and comparing the requests with data from third party services and submitted bids; and responding with the best matching bid. Hence the RTBS 130 is configured so as to receive from a broadcasting station such as, for example, the RTBS 130, a request for placement of bids accompanied by various metadata.

Based on the request, the RTBS 130 is configured to perform the bidding in order to timely provide a selection of an advertisement that meets the criteria for placement as an advertisement in the video stream of that broadcasting station. The RTBS 130 may apply different bidding strategies, such as those discussed above. The RTBS 130 may be further configured to determine a time for the end of the bidding that is sufficient to upload an advertisement if it is not available in-line at the broadcasting station.

FIG. 4 depicts an exemplary and non-limiting schematic block diagram of the RTBS 130 according to another embodiment. In some exemplary implementations, the RTBS 130 comprises a scoring engine (SE) 410, a bid comparison engine (BCE) 420, a bid response engine (BRE) 430, an agency bidding interface (ABI) 450, and a data storage 440, that are communicatively connected through a bus 460 for exchange of data and information as may be required.

In one embodiment, the data storage 440 is used for storing and retrieving of data stored therein by any one of the scoring engine 410, the bid comparison engine 420, and the bid response engine 430. In an embodiment, the data storage 440 includes the bidding rules defined by the advertisement agencies and data received from external sources, such as those defined above.

The agency bidding interface 450 allows for external communication of the RTBS 130. In an embodiment, the interface 440 allows receiving bidding rules set by the advertisement agencies and information from the external sources. In some exemplary implementations, the agency bidding interface 440 exposes a set of application programming interfaces (APIs) to the various advertisement agencies.

The agency bidding interface may, in one embodiment, be rule based, where the rules are predefined or defined in real-time based on needs of agencies, the services provided, and/or the broadcasting station.

The scoring engine 410 is configured to receive incoming bidding requests from at least one broadcaster. Each such bidding request for an advertisement slot in a televised or streamed content is provided by the broadcaster. A bidding request for a slot is received immediately prior to the timing of the slot in the televised or streamed content, thereby providing a real-time bidding request. In an embodiment, the bidding request may receive a minimum score, i.e., the minimum offer that the TSS would accept for “acquiring” the data slot.

The scoring engine 410 is further configured to match each received request to the plurality of bidding rules saved in the storage 440 and to compute a total score for the bid request for each advertisement agency. The score for each bid request for an advertisement agency is computed if the bidding rules defined by the advertisement agency satisfy the bid request. The score of the incoming request for each agency represents an offer to the agency to the request.

As an example, a bid request can be matched against bidding rules of advertisement agencies AG1, AG2, AG3, AG4, and AG5 having scores 10, 8, 4, 0, and 8, respectively. It is determined that the rules set by AG4 do not match the request. In an exemplary embodiment, in the case where multiple bids have an equal highest score (e.g., from AG2 and AG5 in the above example), then the selected bid is that which has the lowest cost bid to the advertisement agency.

The bid comparison engine 420 is configured to receive the bids, i.e., computed scores for the advertisement agencies that have at least one matching bid received, and to select the bid which provides the highest offer among the various advertisement agencies for submission. Such selection, in one embodiment, may be based on bidding strategies discussed in detail above.

The bid response engine 430 is then tasked with the responsibility to timely notify and place the selected bid with a relevant broadcaster, i.e., the broadcaster that has initiated the process for the respective receipt of bids on an advertisement slot in a broadcast television stream.

The various embodiments disclosed herein can be implemented as hardware, firmware, software or any combination thereof. Moreover, the software is preferably implemented as an application program tangibly embodied on a program storage unit, a non-transitory computer readable medium, or a non-transitory machine-readable storage medium that can be in a form of a digital circuit, an analog circuit, a magnetic medium, or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

While the disclosed embodiments have been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A method for bidding on placement of a video advertisement in an advertisement slot, comprising:
receiving a bid request for placing an advertisement in an advertisement slot from a broadcaster, wherein the bid request is received immediately prior to a timing of the advertisement slot in a broadcast content;
matching the bid request against different sets of bidding rules, wherein each set of bidding rules is defined by a different advertisement agency;
computing a bidding score for each advertisement agency based on the matching to the bidding rules;
selecting a winning bid based, in part, on bidding scores computed for each advertisement agency; and
responding with the winning bid from the broadcaster.

2. The method of claim 1, wherein the bid request is rule-based.

3. The method of claim 1, wherein a bidding rule defines one or more criteria for the bid and is associated with a score if the one or more criteria are satisfied.

4. The method of claim 3, wherein the one or more criteria is at least one of: a broadcasting location, a television (TV) channel broadcasting of a desired spot, program information respective of a television show programmed during the desired spot, viewer data, and information regarding advertisement.

5. The method of claim 3, wherein the viewer data includes at least one of: ratings data, total viewers, and demographic data.

6. The method of claim 1, wherein selecting the winning bid further comprising:
selecting the highest scores among the advertisement agencies.

7. The method of claim 1, wherein selecting the winning bid further comprising:
applying a plurality of bidding strategies.

8. The method of claim 1, wherein responding with the winning bid further comprising:
checking if the timing of the advertisement slot in a broadcast content has not elapsed; and
causing for selection of an advertisement to be placed in the advertisement slot.

9. The method of claim 1, wherein the broadcast content is at least one of: televised content broadcast by a television station, and over-the-top (OTT) content broadcast by an OTT content provider.

10. A non-transitory computer readable medium having stored thereon instructions for causing one or more processing units to execute the method according to claim 1.

11. A system for bidding on placement of a video advertisement in an advertisement slot, comprising:
a processor; and
a memory communicatively connected to the processor, the memory containing instructions that, when executed by the processor, configure the system to:
receive a bid request for placing an advertisement in an advertisement slot is received from a broadcaster, wherein the bid request is received immediately prior to a timing of the advertisement slot in a broadcast content;
match the bid request against different sets of bidding rules, wherein each set of bidding rules is defined by a different advertisement agency;
compute a bidding score for each advertisement agency based on the matching to the bidding rules;
select a winning bid based, in part, on bidding scores computed for each advertisement agency; and
respond with the winning bid from the broadcaster.

12. The system of claim 11, wherein the bid request is rule-based.

13. The system of claim 11, wherein a bidding rule defines one or more criteria for the bid and is associated with a score if the one or more criteria are satisfied.

14. The system of claim 13, wherein the one or more criteria is at least one of: a broadcasting location, a television (TV) channel broadcasting of a desired spot, program information respective of a television show programmed during the desired spot, viewer data, and information regarding advertisement.

15. The system of claim 13, wherein the viewer data includes at least one of: ratings data, total viewers, and demographic data.

16. The system of claim 11, wherein the system is further configured to:
select the highest scores among the advertisement agencies.

17. The system of claim 11, wherein the system is further configured to:
apply a plurality of bidding strategies.

18. The system of claim 11, wherein the system is further configured to:
check if the timing of the advertisement slot in a broadcast content has not elapsed; and
cause for selection of an advertisement to be placed in the advertisement slot.

19. The system of claim 11, wherein the broadcast content is at least one of:
televised content broadcast by a television station and over-the-top (OTT) content broadcast by an OTT content provider.
